(19) United States
(12) Patent Application Publication
(10) Pub. No.: US 2020/0131316 A1
(43) Pub. Date: Apr. 30, 2020

(54) (METH)ACRYLOYL GROUP-CONTAINING ORGANOSILOXANE

(71) Applicant: Shin-Etsu Chemical Co., Ltd., Tokyo (JP)

(72) Inventor: Hiroyuki IGUCHI, Annaka-shi (JP)

(73) Assignee: Shin-Etsu Chemical Co., Ltd., Tokyo (JP)

(21) Appl. No.: 16/665,221

(22) Filed: Oct. 28, 2019

(30) Foreign Application Priority Data
Oct. 29, 2018 (JP) 2018-202925

(51) Int. Cl. C08G 77/18; C08G 77/08

(52) U.S. Cl. CPC C08G 77/18; C08G 77/08

(57) ABSTRACT

One of the purposes of the present invention is to provide a (meth)acryloyl group-containing organosiloxane which provides a strong cured product showing excellent adhesion to a substrate. The present invention provides a (meth)acryloyl group-containing organosiloxane represented by the following formula (1):

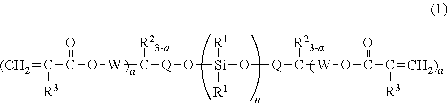

wherein R¹ is, independently of each other, an aliphatic hydrocarbon group having 1 to 10 carbon atoms or an aromatic hydrocarbon group having 6 to 12 carbon atoms, R² is, independently of each other, a hydrogen atom, an alkoxy group having 1 to 6 carbon atoms, an aryloxy or aralkyloxy group having 6 to 12 carbon atoms, an aliphatic hydrocarbon group having 1 to 6 carbon atoms, or an aromatic hydrocarbon group having 6 to 12 carbon atoms, R³ is, independently of each other, a hydrogen atom or a methyl group, Q is a single bond or an alkylene group having 1 to 6 carbon atoms, W is a divalent hydrocarbon group which has 1 to 6 carbon atoms and may have an ether bond, a is an integer of from 1 to 3, and n is an integer of from 1 to 6; and a method for preparing the same.

### CROSS REFERENCE

This application claims the benefits of Japanese Patent Application No. 2018-202925 filed on Oct. 29, 2018, the contents of which are hereby incorporated by reference.

### FIELD OF THE INVENTION

The present invention relates to an organosiloxane having at least two (meth)acryloyl groups and a method for preparing the same.

Various (meth)acryloyl group-containing organosiloxanes are known as an additive for UV-curable materials or a crosslinking agent for addition-curable or UV-curable silicone rubbers. For example, JP application Laid-Open No. 2010-248446, Patent Literature 1, describes a silicone resin composition for encapsulating optical semiconductors, which composition is excellent in curing and adhesion property, and also describes a (meth)acryloyl group-containing organopolysiloxane which has at least two (meth)acryloyl groups and at least one alkoxysilyl group and has a weight average molecular weight of from 10,000 to 150,000.

JP application Laid-Open No. 2015-101562, Patent Literature 2, describes a (meth)acryloyl group-containing organohydrogensiloxane which has both a hydrosilyl group and a (meth)acryloyl group in a molecule, so as to simultaneously cause heat curing and UV curing and, therefore, to be useful as a crosslinking agent. WO2018/003381, Patent Literature 3, describes a UV-curable silicone composition comprising a specific UV-curable organopolysiloxane component, a monofunctional ethylene group-containing compound having no siloxane structure and/or a polyfunctional, ethylene group-containing compound having no siloxane structure.

### PRIOR LITERATURES

Patent Literature 1: JP application Laid-Open No. 2010-248446
Patent Literature 2: JP application Laid-Open No. 2015-101562
Patent Literature 3: WO2018/003381

### SUMMARY OF THE INVENTION

One of the purposes of the present invention is to provide a (meth)acryloyl group-containing organosiloxane which provides a strong cured product showing excellent adhesion to a substrate.

The present inventors have made research on an organosiloxane having at least two, preferably at least four, (meth)acryloyl groups in a molecule, and have invented a (meth)acryloyl group-containing organosiloxane represented by the following formula.

Thus, the present invention provides a (meth)acryloyl group-containing organosiloxane represented by the following formula (1):

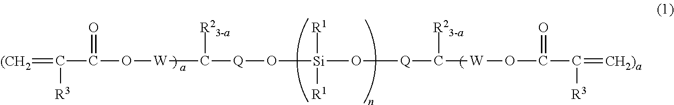

wherein R¹ is, independently of each other, an aliphatic hydrocarbon group having 1 to 10 carbon atoms or an aromatic hydrocarbon group having 6 to 12 carbon atoms, R² is, independently of each other, a hydrogen atom, an alkoxy group having 1 to 6 carbon atoms, an aryloxy or aralkyloxy group having 6 to 12 carbon atoms, an aliphatic hydrocarbon group having 1 to 6 carbon atoms, or an aromatic hydrocarbon group having 6 to 12 carbon atoms, R³ is, independently of each other, a hydrogen atom or a methyl group, Q is a single bond or an alkylene group having 1 to 6 carbon atoms, W is a divalent hydrocarbon group which has 1 to 6 carbon atoms and may have an ether bond, a is an integer of from 1 to 3, and n is an integer of from 1 to 6; and a method for preparing the same.

### Effects of the Invention

The (meth)acryloyl group-containing organosiloxane of the present invention has at least two (meth)acryloyl groups in a molecule and, therefore, provides a very strong cured product. Further, a moiety having a (meth)acryloyl-containing group and a moiety of organosiloxane are connected with each other via a —C—O—Si— structure and, thereby, a cured product has excellent adhesion to a substrate.

### BRIEF EXPLANATION OF THE DRAWING

FIG. 1 is a ¹H-NMR chart of the compound prepared in Example 1.

### DETAILED DESCRIPTION OF THE INVENTION

The present invention will be described in more detail.

The (meth)acryloyl-modified organosiloxane of the present invention is represented by the following formula (1):

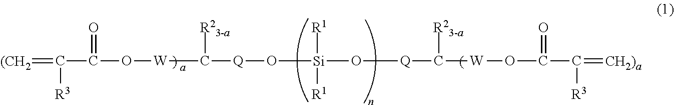

wherein R¹ is, independently of each other, an aliphatic hydrocarbon group having 1 to 10 carbon atoms or an aromatic hydrocarbon group having 6 to 12 carbon atoms, R² is, independently of each other, a hydrogen atom, an alkoxy group having 1 to 6 carbon atoms, an aryloxy or aralkyloxy group having 6 to 12 carbon atoms, an aliphatic hydrocarbon group having 1 to 6 carbon atoms, or an aromatic hydrocarbon group having 6 to 12 carbon atoms, R³ is, independently of each other, a hydrogen atom or a methyl group, Q is a single bond or an alkylene group having 1 to 6 carbon atoms, W is a divalent hydrocarbon group which has 1 to 6 carbon atoms and may have an ether bond, a is an integer of from 1 to 3, and n is an integer of from 1 to 6.

R¹ is, independently of each other, an aliphatic hydrocarbon group having 1 to 10 carbon atoms or an aromatic hydrocarbon group having 6 to 12 carbon atoms, preferably an aliphatic hydrocarbon group having 1 to 6 carbon atoms or an aromatic hydrocarbon group having 6 to 10 carbon atoms, more preferably an aliphatic hydrocarbon group having 1 to 3 carbon atoms or an aromatic hydrocarbon group having 6 to 8 carbon atoms. Examples of the aliphatic hydrocarbon group include alkyl groups such as a methyl, ethyl, propyl or butyl group and cycloalkyl groups such as a cyclopentyl or cyclohexyl group. Among these, a methyl group and a cyclohexyl group are preferred, and a methyl group is particularly preferred. Examples of the aromatic hydrocarbon group include aryl groups such as a phenyl, tolyl, naphthyl or biphenyl group and aralkyl groups such as a benzyl, phenylethyl or phenylpropyl group. Among these, a phenyl group is preferred.

R² is, independently of each other, a hydrogen atom, an alkoxy group having 1 to 6 carbon atoms, an aryloxy or aralkyloxy group having 6 to 12 carbon atoms, an aliphatic hydrocarbon group having 1 to 6 carbon atoms, or an aromatic hydrocarbon group having 6 to 12 carbon atoms. Examples of the aliphatic hydrocarbon group and the aromatic hydrocarbon group include those given as examples of R¹. Examples of the alkoxy group include alkyloxy groups such as a methoxy, ethoxy, propoxy or butoxy group and cycloalkyloxy groups such as a cyclopentyloxy or cyclohexyloxy group. Among these, a methoxy group and an ethoxy group are preferred, and a methoxy group is particularly preferred. Examples of the aryloxy group include a phenoxy, tolyloxy, naphthoxy or biphenyloxy group. Examples of the aralkyloxy group include a benzyloxy, phenylethoxy or phenylpropoxy group. Among these, a phenoxy group is preferred. R² is preferably a hydrogen atom, an alkoxy group having 1 to 3 carbon atoms, an aryloxy group having 6 to 10 carbon atoms, an alkyl group having 1 to 3 carbon atoms, or an aryl group having 6 to 10 carbon atoms, more preferably a hydrogen atom, an alkoxy group having 1 or 2 carbon atoms, an aryloxy group having 6 to 8 carbon atoms, an alkyl group having 1 or 2 alkyl groups, or an aryl group having 6 to 8 carbon atoms.

Q is a single bond or an alkylene group having 1 to 6, preferably 1 to 4 carbon atoms and preferably a single bond or methylene. n is an integer of from 1 to 6, preferably an integer from 1 to 4, more preferably 1 or 2; and a is an integer of from 1 to 3, preferably 2 or 3. W is a divalent hydrocarbon group which has 1 to 6, preferably 1 to 3 carbon atoms and may have an ether bond. Examples of W include alkylene groups such as a methylene group and an ethylene group and oxyalkylene groups such as an oxyethylene group. Preferred is an alkylene group having 1 to 6, more preferably 1 to 3 carbon atoms, and particularly a methylene group.

Examples of the (meth)acryloyl group-containing organosiloxane represented by the formula (1) include compounds represented by the following formulas:

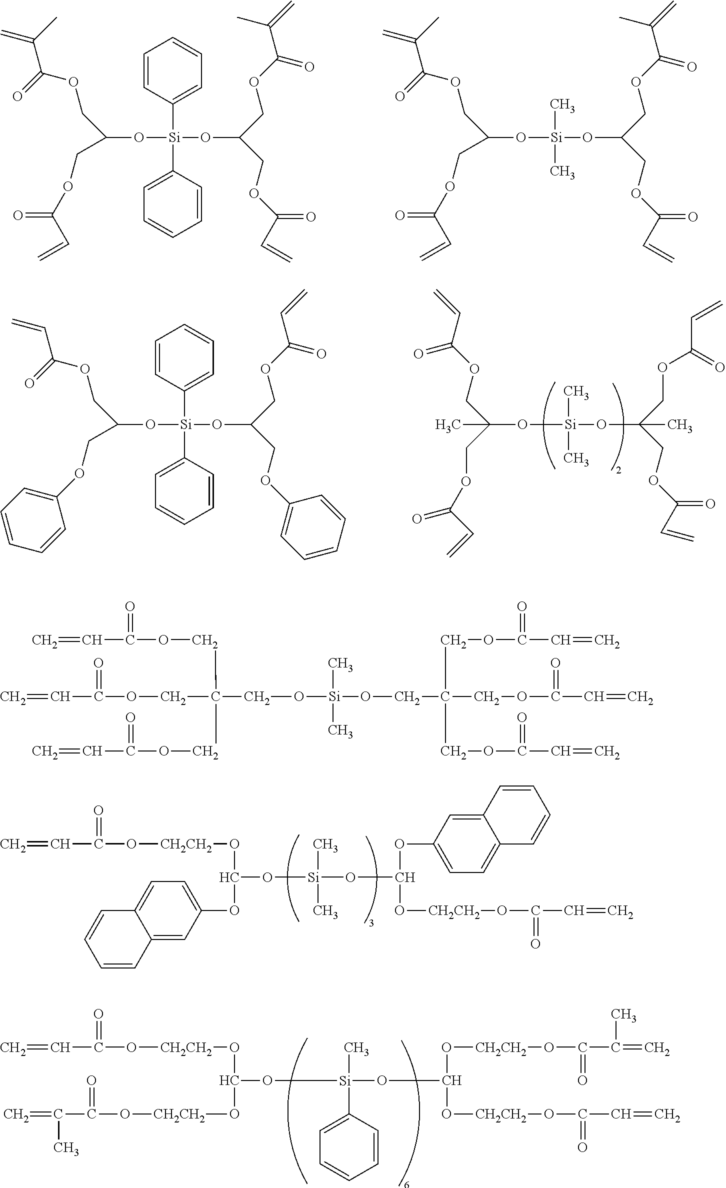

[Method for Preparing the (Meth)Acryloyl Group-Contained Organosiloxane]

A method for preparing the (meth)acryloyl group-contained organosiloxane of the present invention will be described in detail below.

The (meth) acryloyl group-containing organosiloxane of the present invention is obtained, for example, by subjecting a (meth)acryloyl group-containing alcohol (A) represented by the following formula (2):

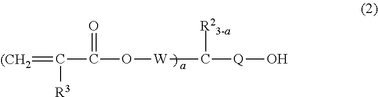

wherein a, R², R³, W, and Q are as defined above, and a chlorosilyl group-containing organosiloxane (B) represented by the following formula (3):

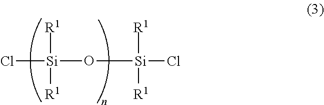

wherein R¹ is as defined above, m=n−1, and n is as defined above, to dehydrochlorination in the presence of a basic catalyst (C).

Examples of the (meth)acryloyl group-containing alcohol represented by the formula (2) include compounds represented by the following formulas.

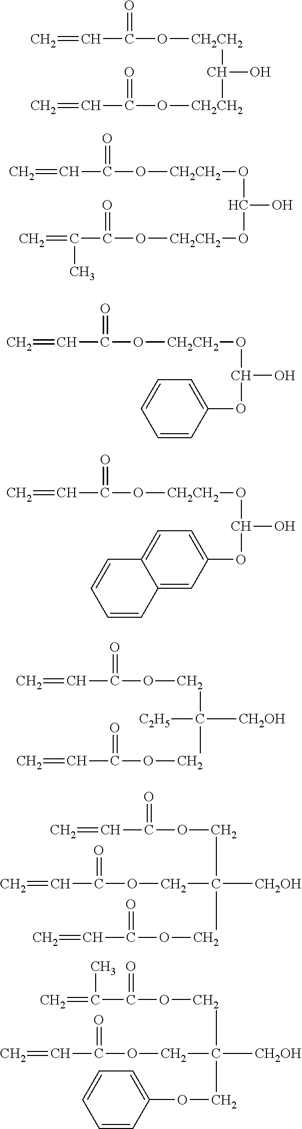

Examples of the chlorosilyl group-containing organosiloxane represented by the formula (3) include compounds represented by the following formulas.

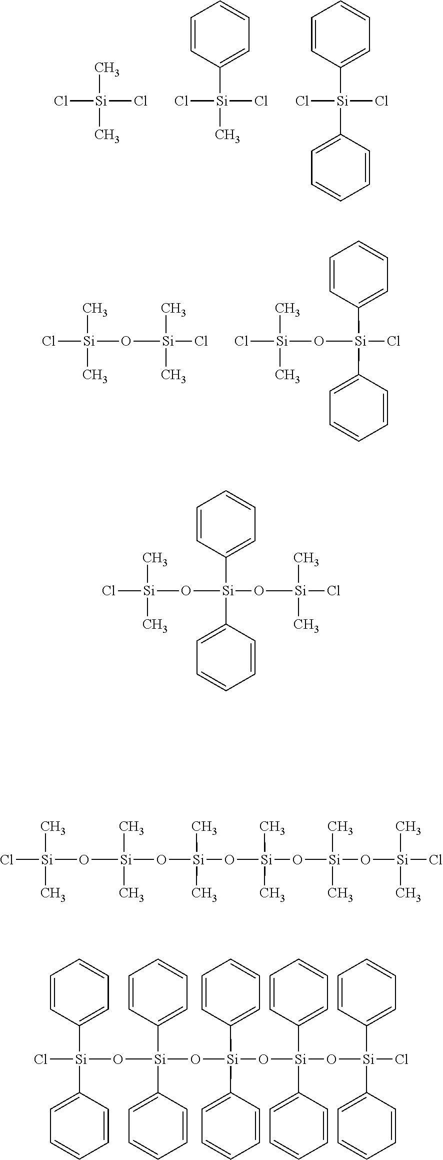

[(C) Basic Catalyst]

The basic catalyst accelerates the dehydrochlorination and is not particularly limited as long as it forms a covalent bond with the hydrogen atom of the hydroxyl group of the (meth)acryloyl group-containing alcohol. Examples of the basic catalyst include amine catalysts, phosphorus catalysts, sulfur catalysts, hydroxide catalysts, and oxide catalysts. Amine catalysts and phosphine catalysts are preferred, and an amine catalyst is more preferred. Reaction conditions of the dehydrochlorination are not particularly limited and may be conducted according to a conventional manner.

Examples of the phosphine catalysts include aliphatic secondary phosphines such as dibutylphosphine and dicyclohexylphosphine, aliphatic tertiary phosphines such as trimethylphosphine, tributylphosphine, and trihexylphosphine, aliphatic diphosphines such as 1,2-(dimethyphosphino)ethane and 1,2-(dibutylphosphino)ethane, aromatic secondary phosphines such as diphenylphosphine, and aromatic tertiary phosphines such as triphenylphosphine and dimethylphenylphosphine. Among these, aliphatic tertiary phosphines and aromatic tertiary phosphines are preferred, and tributylphosphine and triphenylphosphine are particularly preferred.

Examples of the amine catalysts include aliphatic primary amines such as butylamine, hexylamine, and octylamine, aliphatic secondary amines such as diethylamine and dibutylamine, aliphatic tertiary amines such as triethylamine, triethanolamine, and N,N-diisopropylethylamine, aliphatic primary diamines such as ethylenediamine, tetramethylethylenediamine, and hexamethylenediamine, aromatic primary amines such as aniline and toluidine, and heterocyclic amines such as pyridine, piperidine, picoline, pyrrole, imidazole, oxazole, thiazole, diazabicycloundecene, and diazabicyclononene. Among these, aliphatic tertiary amines and heterocyclic amines are preferred, and triethylamine and pyridine are particularly preferred.

The dehydrochlorination may be conducted according to a conventional manner. For example, an amount of the (meth)acryloyl group-containing alcohol represented by the formula (2) may be 1 mol to 3 mol, per mol of the chlorosilyl group-containing organosiloxane represented by the formula (3). An amount of the catalyst may be a catalytically effective amount (catalytic amount) for making the dehydrochlorination proceed. For example, the amount is 1 mol to 3 mol, per mol of the (meth)acryloyl group-containing alcohol. Concerning reaction conditions, the reaction may be conducted, for example, at a temperature in a range of from 30 to 60 degrees C. for 2 to 5 hours.

### EXAMPLES

The present invention will be explained below in further detail with reference to a series of the Examples, and the present invention is in no way limited by these Examples.

In the Examples, ¹H-NMR measurement was done by an equipment produced by BRUKER, using deuterochloroform as a solvent and chloroform as an internal standard.

### Example 1

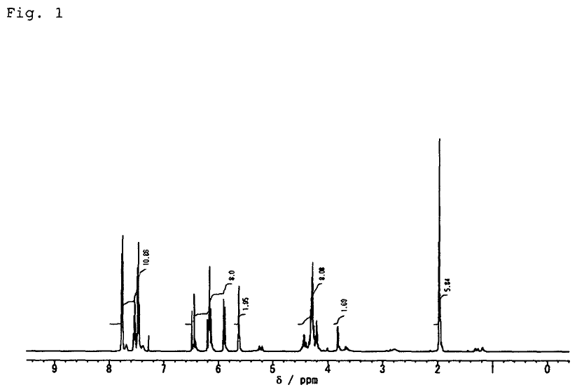

Dichlorodiphenylsilane (506 g) and toluene (506 g) were placed in a 5-L brown flask. After stirring for 10 minutes, 2-hydroxy-3-acryloxypropyl methacrylate (854 g, “NK Ester 701A”, ex Shin-Nakamura Chemical) was added, followed by stirring for 10 minutes. Triethylamine (547 g) was added dropwise to the mixture, followed by stirring at 60 degrees C. for 3 hours. The reaction mixture was subjected to filtration and to distillation at a reduced pressure to obtain a colorless transparent liquid product (yield, 750 g). According to the chemical shifts and the integration ratios by ¹H-NMR analysis, the product obtained was found to be a compound (A-1) represented by the following formula. The ¹H-NMR chart is shown as FIG. 1.

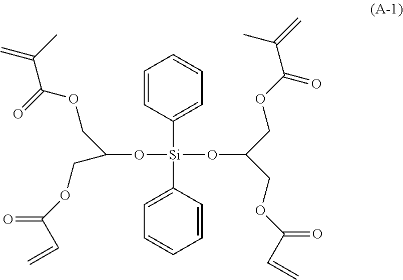 [SMILES: C=CC(=O)OCC(COC(=O)C(=C)C)O[Si](OC(COC(=O)C=C)COC(=O)C(=C)C)(c1ccccc1)c1ccccc1]

The chemical shifts and the integration ratios of ¹H-NMR are as follows.

δ2.0 (CH₂═C(CH₃) C(O) OCH₂CH(O)CH₂OC(O)CH═CH₂)6H

δ3.9 (CH₂═C(CH₃) C(O) OCH₂CH(O)CH₂OC(O)CH═CH₂)2H

δ4.1-4.5 (CH₂═C(CH₃) C(O) OCH₂CH(O)CH₂OC(O)CH═CH₂)8H

δ5.6 (CH₂═C(CH₃) C(O) OCH₂CH(O)CH₂OC(O) CH═CH₂)2H

δ5.8-6.5 (CH₂═C(CH₃) C(O) OCH₂CH(O)CH₂OC(O)CH═CH₂)8H

δ7.4-7.8 (C₆H₅SiOC₆H₅)10H

### Example 2

Dichlorodiphenylsilane (506 g) and toluene (506 g) were placed in a 5-L brown flask. After stirring for 10 minutes, 2-hydroxy-3-phenoxypropyl acrylate (977 g, “KAYARAD R-128H”, ex Nippon Kayaku) was added, followed by stirring for 10 minutes. Triethylamine (607 g) was added dropwise to the mixture, followed by stirring at 60 degrees C. for 3 hours. The reaction mixture was subjected to filtration and to distillation at a reduced pressure to obtain a colorless transparent liquid product (yield, 813 g). According to the chemical shifts and the integration ratios by ¹H-NMR analysis, the product obtained was found to be a compound (A-2) represented by the following formula.

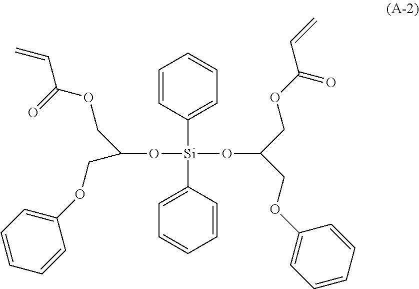 [SMILES: C=CC(=O)OCC(COc1ccccc1)O[Si](OC(COC(=O)C=C)COc1ccccc1)(c1ccccc1)c1ccccc1]

The chemical shifts and the integration ratios of ¹H-NMR are as follows.

δ3.8-4.6 (C₆H₅OCH₂CH(O) CH₂OC(O)CH—CH₂)10H

δ5.8-6.5 (—OC(O) CH═CH₂)6H

δ6.7-7.8 (C₆H₅OCH₂, C₆H₅SiOC₆H₅)20H

### Example 3

Dichlorodimethylsilane (258 g) and toluene (258 g) were placed in a 5-L brown flask. After stirring for 10 minutes, 2-hydroxy-3-acryloxypropyl methacrylate (854 g) was added, followed by stirring for 10 minutes. Triethylamine (547 g) was added dropwise to the mixture, followed by stirring at 60 degrees C. for 3 hours. The reaction mixture was subjected to filtration and to distillation at a reduced pressure to obtain a colorless transparent liquid product (yield, 630 g). According to the chemical shifts and the integration ratios by ¹H-NMR analysis, the product obtained was found to be a compound (A-3) represented by the following formula.

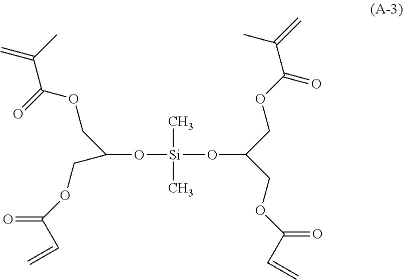 [SMILES: C=CC(=O)OCC(COC(=O)C(=C)C)O[Si](C)(C)OC(COC(=O)C=C)COC(=O)C(=C)C]

The chemical shifts and the integration ratios of ¹H-NMR are as follows.

δ0.0-0.5 (CH₃SiOCH₃)6H

δ1.9 (CH₂═C(CH₃) C(O) OCH₂CH(O)CH₂OC(O)CH═CH₂)6H

δ3.7-3.9 (CH₂═C(CH₃) C(O) OCH₂CH(O)CH₂OC(O)CH═CH₂)2H

δ4.1-4.5 (CH₂═C(CH₃) C(O) OCH₂CH(O)CH₂OC(O)CH═CH₂)8H

δ5.6 (CH₂═C(CH₃) C(O) OCH₂CH(O)CH₂OC(O) CH═CH₂)2H

δ5.8-6.5 (CH₂═C(CH₃) C(O) OCH₂CH(O)CH₂OC(O)CH═CH₂)8H

### Example 4

1, 1, 3, 3-Tetramethyl-1,3-dichlorodisiloxane (406 g) and toluene (406 g) were placed in a 5-L brown flask. After stirring for 10 minutes, 2-hydroxy-2-methyl-3-acryloxypropyl acrylate (854 g) was added, followed by stirring for 10 minutes. Triethylamine (548 g) was added dropwise to the mixture, followed by stirring at 60 degrees C. for 3 hours. The reaction mixture was subjected to filtration and to distillation at a reduced pressure to obtain a colorless transparent liquid product (yield, 720 g). According to the chemical shifts and the integration ratios by ¹H-NMR analysis, the product obtained was found to be a compound (A-4) represented by the following formula.

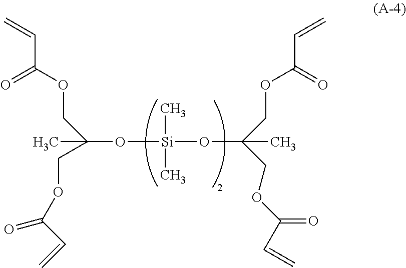

The chemical shifts and the integration ratios of ¹H-NMR are as follows.

δ0.0-0.5 (CH₃SiOCH₃)12H

δ1.8-2.3 (CH₂═CHC(O) OCH₂C(CH₃)(O)CH₂OC(O)CH═CH₂)6H

δ4.0-4.6 (CH₂═CHC(O) OCH₂C(CH₃)(O)CH₂OC(O)CH═CH₂)8H

δ5.6 (CH₂═CHC(O) OCH₂C(CH₃)(O)CH₂OC(O) CH═CH₂)4H

δ5.8-6.6 (CH₂═CHC(O) OCH₂C(CH₃)(O)CH₂OC(O)CH═CH₂)8H

### Example 5

1, 1, 3, 3, 5, 5, 7, 7-Octamethyl-1, 7-dichlorotetrasiloxane (703 g) and toluene (703 g) were placed in a 5-L brown flask. After stirring for 10 minutes, pentaerythritol triacrylate (1,311 g, “NK Ester A-TMM-3LM-N”, ex Shin-Nakamura Chemical) was added, followed by stirring for 10 minutes. Triethylamine (607 g) was added dropwise to the mixture, followed by stirring at 60 degrees C. for 3 hours. The reaction mixture was subjected to filtration and to distillation at a reduced pressure to obtain a colorless transparent liquid product (yield, 1,550 g). According to the chemical shifts and the integration ratios by ¹H-NMR analysis, the product obtained was found to be a compound (A-5) represented by the following formula.

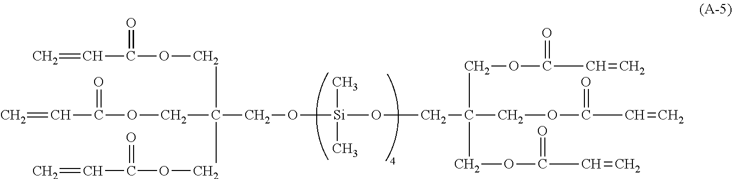

The chemical shifts and the integration ratios of ¹H-NMR are as follows.

δ0.0-0.5 (CH₃SiOCH₃)24H

δ3.7-4.0 (C—CH₂OC(O)CH—CH₂)12H

δ4.3-4.5 (SiO—CH₂C(CH₂OC(O)CH═CH₂)₃)4H

δ5.8-6.5 (C—CH₂OC(O)CH═CH₂)18H

The organosiloxane of the present invention has at least two (meth)acryloyl groups, so that it provides a very strong cured product. A moiety having a (meth)acryloyl-containing group and an organosiloxane moiety are connected with each other via a —C—O—Si— structure in the present organosiloxane. Accordingly, its cured product is resinous and excellent in adhesion to a substrate. The present organosiloxane is useful, for instance, the present organosiloxane is mixed with a polymerization initiator to give a heat-curable resin composition or a light-curable resin composition which cures by exposure to UV rays or electron rays.

1. A (meth)acryloyl group-containing organosiloxane represented by the following formula (1): 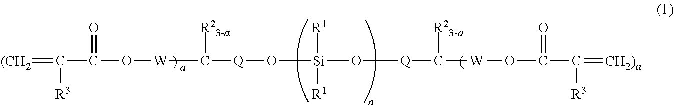
wherein R¹ is, independently of each other, an aliphatic hydrocarbon group having 1 to 10 carbon atoms or an aromatic hydrocarbon group having 6 to 12 carbon atoms, R² is, independently of each other, a hydrogen atom, an alkoxy group having 1 to 6 carbon atoms, an aryloxy or aralkyloxy group having 6 to 12 carbon atoms, an aliphatic hydrocarbon group having 1 to 6 carbon atoms, or an aromatic hydrocarbon group having 6 to 12 carbon atoms, R³ is, independently of each other, a hydrogen atom or a methyl group, Q is a single bond or an alkylene group having 1 to 6 carbon atoms, W is a divalent hydrocarbon group which has 1 to 6 carbon atoms and may have an ether bond, a is an integer of from 1 to 3, and n is an integer of from 1 to 6.

2. The (meth)acryloyl group-containing organosiloxane according to claim 1, wherein R² is a hydrogen atom, an alkoxy group having 1 to 3 carbon atoms, an aryloxy group having 6 to 10 carbon atoms, an alkyl group having 1 to 3 carbon atoms, or an aryl group having 6 to 10 carbon atoms.

3. The (meth)acryloyl group-containing organosiloxane according to claim 1 or 2, wherein Q is a single bond or an alkylene group having 1 to 3 carbon atoms.

4. The (meth)acryloyl group-containing organosiloxane according to claim 1, wherein a is 2 or 3.

5. A method for preparing a (meth)acryloyl group-containing organosiloxane represented by the following formula (1): 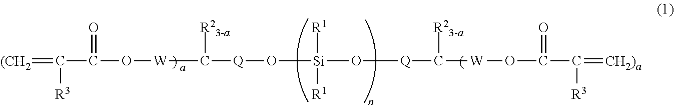
wherein R¹ is, independently of each other, an aliphatic hydrocarbon group having 1 to 10 carbon atoms or an aromatic hydrocarbon group having 6 to 12 carbon atoms, R² is, independently of each other, a hydrogen atom, an alkoxy group having 1 to 6 carbon atoms, an aryloxy or aralkyloxy group having 6 to 12 carbon atoms, an aliphatic hydrocarbon group having 1 to 6 carbon atoms, or an aromatic hydrocarbon group having 6 to 12 carbon atoms, R³ is, independently of each other, a hydrogen atom or a methyl group, Q is a single bond or an alkylene group having 1 to 6 carbon atoms, W is a divalent hydrocarbon group which has 1 to 6 carbon atoms and may have an ether bond, a is an integer of from 1 to 3, and n is an integer of from 1 to 6,
wherein the method comprises a step of reacting a (meth)acryloyl group-containing alcohol represented by the following formula (2): 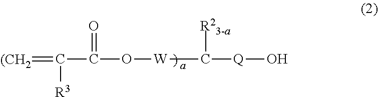
wherein a, R², R³, W and Q are as defined above,
with a chlorosilyl group-containing organosiloxane represented by the following formula (3): 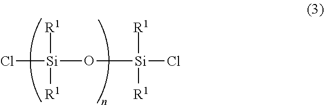
wherein R¹ is as defined above, m=n−1, and n is as defined above,
in the presence of (C) a basic catalyst.

6. The method according to claim 5, wherein component (C) is an amine catalyst.

7. The method according to claim 5 or 6, wherein a is 2 or 3.
